(19) United States
(12) Patent Application Publication
(10) Pub. No.: US 2017/0094231 A1
(43) Pub. Date: Mar. 30, 2017

(54) SCENE RECONSTRUCTION USING PRE-BUFFERING IN SENSOR TRIGGERED AUTOMOBILE CAMERAS

(71) Applicant: Faraday&Future Inc., Gardena, CA (US)

(72) Inventor: Marco Elkenkamp, Marina Del Rey, CA (US)

(21) Appl. No.: 14/868,919

(22) Filed: Sep. 29, 2015

(51) Int. Cl. H04N 7/18; G11B 27/11; G11B 27/34; H04N 5/77

(52) U.S. Cl. CPC H04N 7/188; H04N 5/77; G11B 27/11; G11B 27/34

(57) ABSTRACT

The present application is directed to systems and methods for capturing video from a sensor triggered camera. External automobile cameras run continuously and content is buffered. Buffer storage is triggered by one or more other automobile sensors to store content beginning at some period of time (e.g. 30 seconds) prior to the triggering of the sensor.

### FIELD OF THE DISCLOSURE

The present disclosure relates generally to the field of video storage, and more specifically to systems and methods to select video to be stored based on a sensor input.

### BACKGROUND

Vehicle-mounted cameras are quickly becoming ubiquitous in today's society. In the United States, most new vehicles are required to have backup cameras by 2018. User-mounted dash cams are becoming increasingly popular, and many believe that forward facing cameras will eventually become mandatory now that backup cameras are prescribed for new cars. Similarly, stationary cameras observing moving vehicles can be found in nearly all urban areas. With so many cameras, both fixed and mobile, in operation it is inevitable that many vehicle incidents (such as collisions) will be caught on video. While many of these cameras are simply for observation, it would take much of the guess work out of vehicle accident reconstruction if the video streams from these cameras could be captured for the time periods when the cameras observe accidents. Such videos could also be used to identify and reduce fraudulent insurance claims.

Due to the size of the video files produced by generally available HD video cameras, it is generally not possible to capture and store video files covering long periods of time, particularly if there are multiple cameras mounted on the vehicle or multiple cameras observing moving vehicles in a certain area. Even the largest storage media associated with mobile cameras can store only a few hours of video. While installing larger storage media in a vehicle is possible, this increases cost and complexity and would require frequent maintenance.

The use of video for accident reconstruction is also dependent on the availability of the video file to the authorities. While it can be easier to obtain a video file for a vehicle involved in an accident, it is indeed difficult if not impossible to obtain video from a vehicle in the vicinity of an accident, but not involved in the accident, if the camera's owner does not voluntarily offer it.

### SUMMARY

The present application is directed to methods for capturing video from a sensor triggered camera. An exemplary method can comprise receiving a video stream from a camera into a buffer storage. The video stream can be associated with a period of time (the period of time from the beginning of the video stream to the end of the video stream). A signal from a sensor can be received that indicates a triggering event that occurred during the period of time of the video stream. A portion of the video stream in the buffered storage can be captured. The portion of the video stream can begin prior to the triggering event and end after the triggering event. The captured portion of the video stream can be a subset of the video stream. The captured portion of the video stream can be saved in memory.

According to additional exemplary embodiments, the present application can be directed to methods for capturing video from a sensor triggered vehicle camera. An exemplary method can comprise receiving a continuous video stream from a camera on a vehicle into a buffer storage. A signal can be received from a sensor on the vehicle to transfer the continuous video stream from the buffer storage to a memory. A first predetermined time can be received from a system controller in which the first predetermined time indicates a time prior to receiving the signal, and initiates a transfer of the continuous video stream from the buffer storage to the memory. A second predetermined time can be received from the system controller in which the second predetermined time indicates a time after receiving the signal, and indicates stopping the transfer of the continuous video stream from the buffer storage to the memory. The continuous video stream can be stored in the memory.

According to further exemplary embodiments, the present application can be directed to systems for capturing video from a sensor triggered vehicle camera. An exemplary system can comprise a camera on a vehicle producing a continuous video stream. A buffer storage can be communicatively coupled to the camera on the vehicle. The buffer storage can store the continuous video stream for a period of time. A sensor can be on the vehicle, the sensor communicatively coupled to the camera, the buffer storage, and a memory on the vehicle. A system controller can be on the vehicle, the system controller communicatively coupled to the camera, the sensor, the buffer storage, and the memory. An intelligent agent can be communicatively coupled over a network to the system controller on the vehicle. The intelligent agent can be configured to receive over the network from the system controller on the vehicle a portion of the saved continuous video stream, an associated time stamp, an associated GPS location, and an associated identifier of the vehicle.

### BRIEF DESCRIPTION OF THE DRAWINGS

FIG. 1 is a schematic diagram of a system to capture video from a sensor triggered camera according to various embodiments.

FIG. 2 is a graphical representation of a continuous video stream in buffered storage a portion of the video stream captured and stored in memory.

FIG. 3 is a schematic diagram of a system to capture video from a sensor triggered vehicle camera according to various embodiments.

FIG. 4 is a flow diagram of an exemplary method for capturing video from a sensor triggered camera according to various embodiments.

FIG. 5 is a flow diagram of an exemplary method for capturing video from a sensor triggered vehicle camera according to various embodiments.

FIG. 6 is a block diagram of an exemplary computing system that can be utilized to practice aspects of the present disclosure according to various embodiments.

### DETAILED DESCRIPTION

The present application is directed to systems and methods for capturing video from a sensor triggered camera. In various embodiments, the camera can be positioned on a moving vehicle. Storage of video files obtained from the camera over a long period is impractical; therefore, it is desirable to capture and store only a portion of the video file related to a specific event, the event being defined by a specific time period. In various embodiments, a video stream from the camera can be buffered, but not continuously stored in memory. A sensor on the vehicle can sense an event for which the video file is to be captured and stored. The extent of the video file captured and stored can encompass a period of time beginning prior to the sensed event and ending a period of time after the sensed event. The captured video file can then be uploaded to an agent through a network communication. Although the description below is directed to vehicle mounted systems, additional exemplary embodiments are envisioned wherein the camera is stationary.

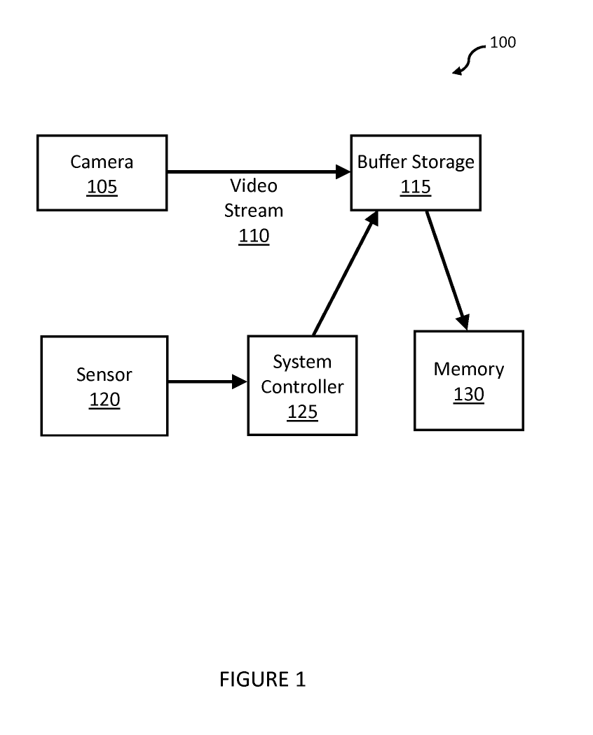

FIG. 1 schematically illustrates various embodiments of a system 100 for capturing video from a sensor triggered camera. The camera 105 can produce a video stream 110 (either continuously or intermittently). A portion of the video stream 110 can be temporarily retained in buffer storage 115. The portion of the video stream 110 retained in the buffer storage 115 can be defined by a period of time. For example, the buffer storage 115 can retain the most recent 10 minutes of the video stream 110. As is apparent to one skilled in the art, the period of time can be any length of time greater than or less than 10 minutes and can be limited only by the amount (e.g., measured in gigabytes) of buffer storage available. One or more sensors 120 can be in communication with a system controller 125. When the sensor 120 senses a triggering event, the sensor 120 communicates with the system controller 125, which in turn communicates with the buffer storage 115. A portion of the video stream 110 related to the triggering event can be stored in memory 130.

The sensor 120 can comprise an ultrasonic or microwave motion detector, vibration sensor, sound sensor, differential pressure sensor, radar sensor, sonar sensor, lidar sensor, light sensor, braking sensor, accelerometer sensor, impact sensor, GPS sensor, video sensor, and the like. In addition, the sensor 120 can comprise a device to monitor the position, condition, activation, etc. of any system within the vehicle itself, such as throttle position or brake actuation. Generally the sensor 120 is capable of ascertaining one or more conditions in the environment of the vehicle. The system 100 can comprise any number of sensors 120.

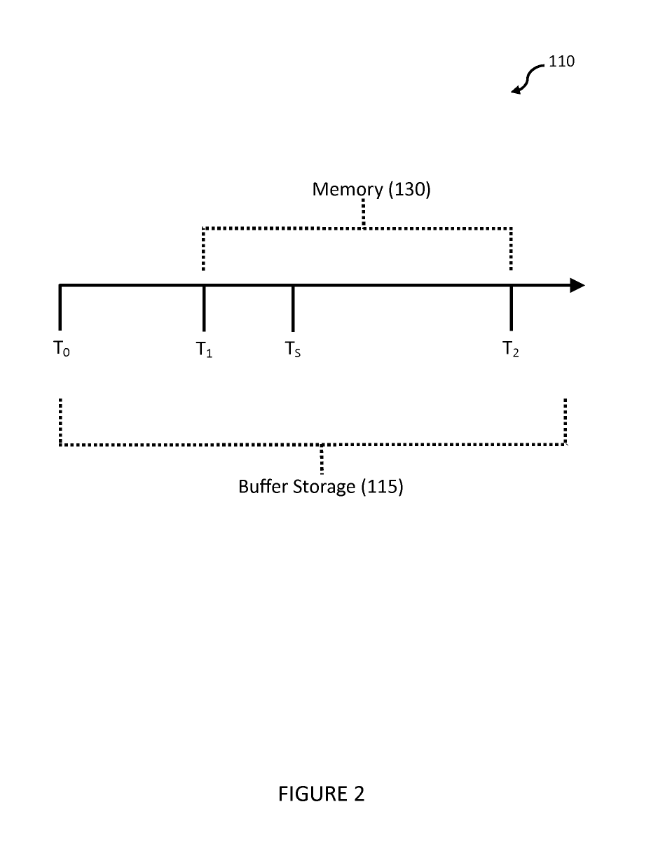

FIG. 2 along with FIG. 1 further illustrates the capture of the portion of the video stream 110 related to the triggering event according to various embodiments. The portion of the video stream 110 retained in the buffer storage 115 can be represented by the arrow in FIG. 2 beginning at an initial time T₀ and extending for the length (e.g., the most recent 10 minutes) of the video stream 110 retained in the buffer storage 115. The triggering event that triggers the sensor 120 can occur at a time T_{S}. Once the sensor 120 communicates the event to the system controller 125, a portion of the video stream 110 retained in the buffer storage 115 is directed to the memory 130. The retained portion of the video stream 110 can be defined by a start time T₁ and an end time T₂. The start time T₁ can be selected to be a predetermined amount of time prior to the time T_{S} of the triggering event. For example T₁ can be selected to be 30 seconds prior to the time T_{S} of the triggering event. Thus, the retained portion of the video stream 110 can capture the circumstances leading up to the triggering event which can aid in determining why the event happened or who/what was at fault for causing the event. The end time T₂ can be any desired period of time after the time T_{S} of the triggering event.

Various embodiments of the system 100 can be particularly relevant for determining the circumstances leading up to a triggering event such as a collision between two vehicles. The video stream 110 can capture video evidence to ascertain whether the driver of one of the vehicles failed to stop at a traffic light or stop sign, was driving erratically or left of center, veered to avoid an obstruction in the road, or any other action or behavior contributing to the event. The video stream 110 can also be useful for determining weather and road conditions at the time of the triggering event.

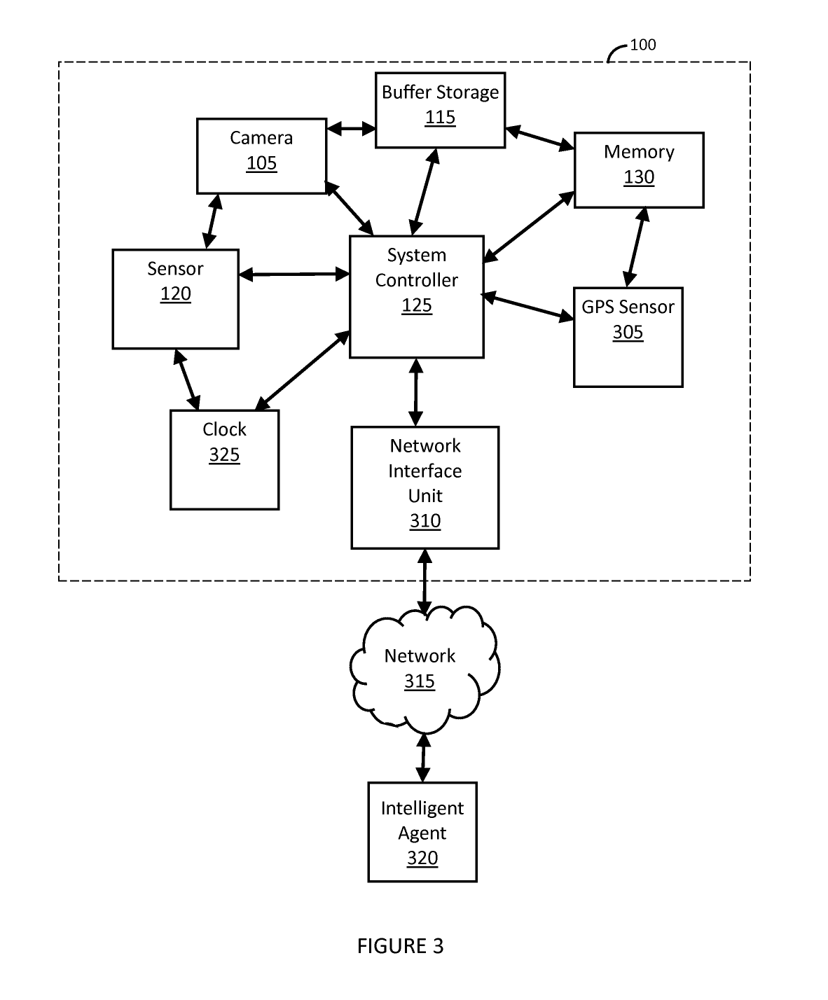

The system 100 according to various embodiments is further illustrated in FIG. 3. The sensor 120, camera 105, buffer storage 115, memory 130, and system controller 125 can be communicatively coupled directly to one another or through one or more of the other components (e.g., the camera 105 can be communicatively coupled to the memory 130 via the system controller 125). The system 100 can further comprise a global positioning system (GPS) sensor 305 that can continuously or intermittently track the vehicle's location, direction of travel, and speed, and a real time clock 325 for providing time stamp data for the video stream 110 and the sensor 120. In addition, the memory 130 or system controller 125 can store various non-video data including but not limited to GPS data (both instantaneous and historical); one or more time stamps for start time T₁ and end time T₂ of the retained portion of the video stream and time T_{S} of the triggering event as illustrated in FIG. 2; identifier of the sensor that was triggered; identifier of the vehicle; identifier of the vehicle driver; vehicle service history; status of other vehicle sensors that sense conditions of the vehicle itself and vehicle subsystems such as engine, electrical, and fuel distribution; and the like.

The system 100 can further comprise a network interface unit 310 through which the system controller 125 can communicate via a network 315 with one or more intelligent agents 320, such as a computer system or network (not shown). The intelligent agent 320 can receive over the network 315 the retained portion of the video stream 110 and any of the non-video data stored in memory 130 or the system controller 125. The network 315 can be a cellular network, the Internet, an Intranet, or other suitable communications network, and can be capable of supporting communication in accordance with any one or more of a number of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth, Wireless LAN (WLAN) protocols/techniques.

The intelligent agent 320, according to some exemplary embodiments, is a non-generic computing device comprising non-generic computing components. The intelligent agent 320 can comprise dedicated hardware processors to determine, transmit, and receive video and non-video data elements. In further exemplary embodiments, the intelligent agent 320 comprises a specialized device having circuitry and specialized hardware processors, and is artificially intelligent, including machine learning. Numerous determination steps by the intelligent agent 320 as described herein can be made to video and non-video data by an automatic machine determination without human involvement, including being based on a previous outcome or feedback (e.g., automatic feedback loop) provided by the networked architecture, processing and/or execution as described herein.

As mentioned previously, the system 100 can be in a stationary position rather than vehicle mounted. For example, the system 100 can be positioned such that the camera 105 can capture an intersection. Sensors 120 can sense vehicle speed, rate of acceleration/deceleration, position, and the like. The sensor 120 can be triggered at time Ts when the position and speed of two vehicles indicates that the vehicles have collided with one another. A portion of the video stream 110 can be captured and stored on memory 130 beginning at a time T₁ prior to time T_{S} (and thus prior to the collision) and ending at a time T₂ some period of time after the collision. Similarly, a portion of the video stream 110 can be captured and stored on memory 130 when the sensor 120 senses a car exceeding a posted speed limit, and the captured portion of the video stream 110 can show the vehicle before and after passing the posted speed limit.

Additionally, the system 100 can be installed in any type of moving vehicle, including automobiles, trucks, buses, trains, and the like. The system 100 can also be installed in airborne vehicles such as airplanes, helicopters, gliders, blimps, balloons, drones, and the like. Although commercial airplanes are equipped with a multitude of sensors and recording systems to record conditions and events while in the air, the system 100 can be useful for incidents that occur on the ground, such as a collision between taxiing airplanes.

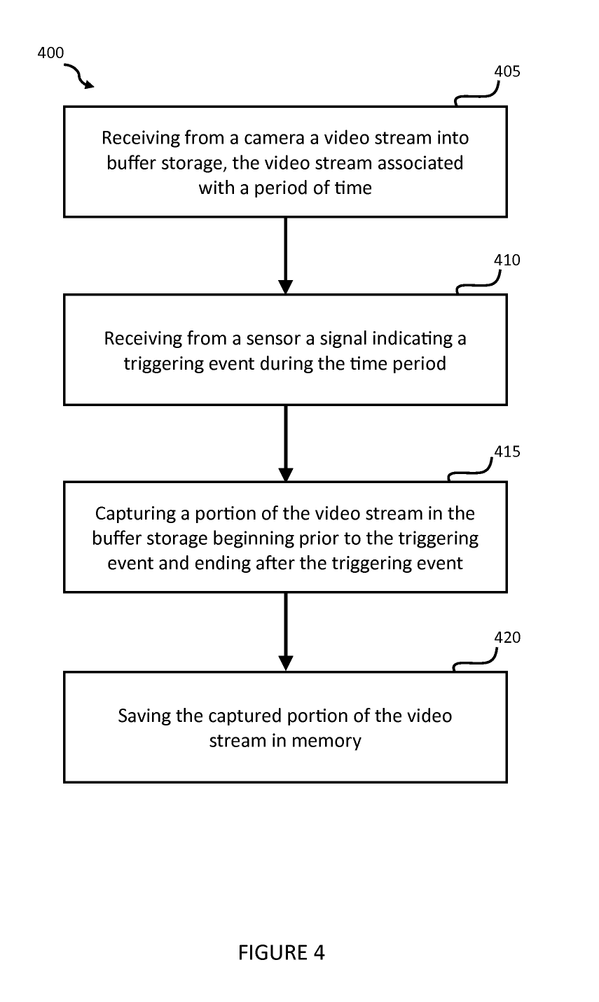

FIG. 4 is a flowchart of an exemplary method 400 for capturing video from a sensor triggered camera. At step 405, as illustrated in FIG. 4 and FIG. 1, a video stream 110 from a camera 105 can be received into a buffer storage 115. The video stream 110 can be associated with a period of time (the period of time from the beginning of the video stream 110 to the end of the video stream 110). A signal from a sensor 120 can be received at step 410 that indicates a triggering event that occurred during the period of time of the video stream 110. A portion of the video stream 110 in the buffered storage 115 can be captured at step 415. The portion of the video stream 110 can begin prior to the triggering event and end after the triggering event. The captured portion of the video stream 110 can be a subset of the video stream 110. At step 420, the captured portion of the video stream 110 can be saved in memory 130.

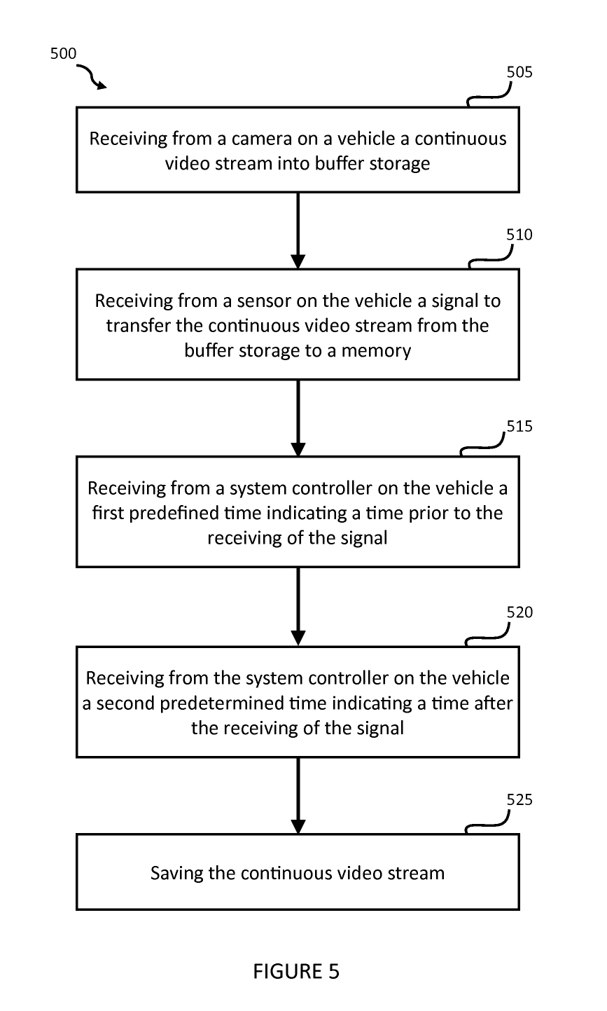

FIG. 5 is a flowchart of an exemplary method 500 for capturing video from a sensor triggered vehicle camera. At step 505, as illustrated in FIG. 5 and FIG. 1, a continuous video stream 110 from a camera 105 on a vehicle can be received into a buffer storage 115. A signal can be received at step 510 from a sensor 120 on the vehicle to transfer the continuous video stream 110 from the buffer storage 115 to a memory 130. At step 515, a first predetermined time can be received from a system controller 125 in which the first predetermined time indicates a time prior to receiving the signal, and initiates a transfer of the continuous video stream 110 from the buffer storage 115 to the memory 130. A second predetermined time can be received from the system controller 125 at step 520 in which the second predetermined time indicates a time after receiving the signal, and indicates stopping the transfer of the continuous video stream 110 from the buffer storage 115 to the memory 130. The continuous video stream 110 can be stored in the memory 130 at step 525.

According to various embodiments, the system controller 125 can communicate with a cloud-based computing environment that collects, processes, analyzes, and publishes datasets. In general, a cloud-based computing environment is a resource that typically combines the computational power of a large grouping of processors and/or that combines the storage capacity of a large group of computer memories or storage devices. For example, systems that provide a cloud resource can be utilized exclusively by their owners, such as Google™ or Yahoo!™, or such systems can be accessible to outside users who deploy applications within the computing infrastructure to obtain the benefits of large computational or storage resources.

The cloud can be formed, for example, by a network of web servers with each server (or at least a plurality thereof) providing processor and/or storage resources. These servers can manage workloads provided by multiple users (e.g., cloud resource customers or other users). Typically, each user places workload demands upon the cloud that vary in real-time, sometimes dramatically. The nature and extent of these variations typically depend upon the type of business associated with each user.

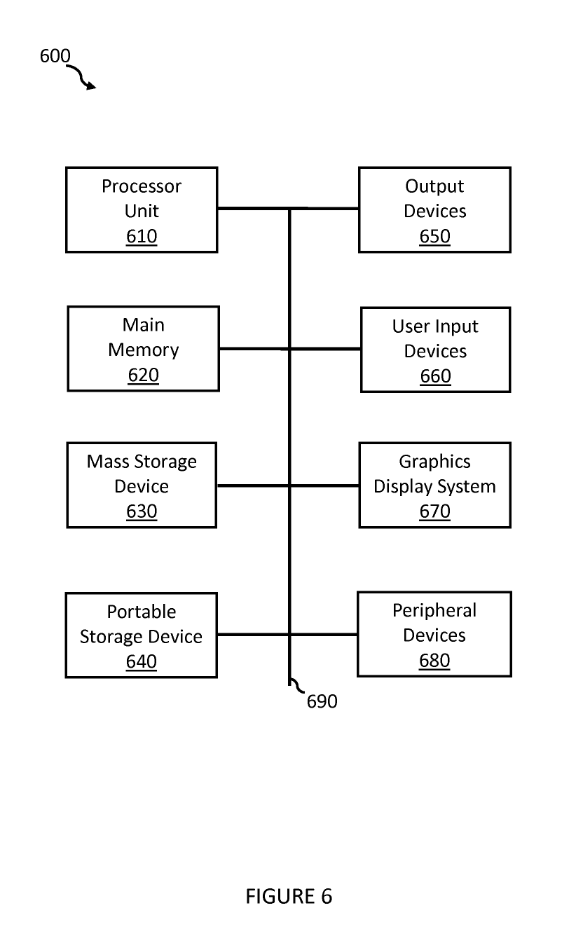

FIG. 6 illustrates an exemplary computing system 600 that can be used to implement an embodiment of the present technology. The computing system 600 of FIG. 6 includes one or more processor units 610 and main memory 620. Main memory 620 stores, in part, instructions and data for execution by processor 610. Main memory 620 can store the executable code when the system 600 is in operation. The system 600 of FIG. 6 can further include a mass storage device 630, portable storage device(s) 640, output devices 650, user input devices 660, a graphics display system 670, and other peripheral devices 680.

The components shown in FIG. 6 are depicted as being connected via a single bus 690. The components can be connected through one or more data transport means. Processor unit 610 and main memory 620 can be connected via a local microprocessor bus, and the mass storage device 630, peripheral device(s) 680, portable storage device(s) 640, and graphics display system 670 can be connected via one or more input/output (I/O) buses.

Mass storage device 630, which can be implemented with a magnetic disk drive or an optical disk drive, is a non-volatile storage device for storing data and instructions for use by processor unit 610. Mass storage device 630 can store the system software for implementing embodiments of the present technology for purposes of loading that software into main memory 620.

Portable storage device 640 operates in conjunction with a portable non-volatile storage media, such as a floppy disk, compact disk or digital video disc, to input and output data and code to and from the computer system 600 of FIG. 6. The system software for implementing embodiments of the present technology can be stored on such a portable media and input to the computer system 600 via the portable storage device 640.

User input devices 660 provide a portion of a user interface. User input devices 660 can include an alphanumeric keypad, such as a keyboard, for inputting alphanumeric and other information, or a pointing device, such as a mouse, a trackball, stylus, or cursor direction keys. Additionally, the system 600 as shown in FIG. 6 includes output devices 650. Suitable output devices include speakers, printers, network interfaces, and monitors.

Graphics display system 670 can include a liquid crystal display (LCD) or other suitable display device. Graphics display system 670 receives textual and graphical information, and processes the information for output to the display device.

Peripheral devices 680 can include any type of computer support device to add additional functionality to the computer system. Peripheral device(s) 680 can include a modem or a router.

The components contained in the computer system 600 of FIG. 6 are those typically found in computer systems that can be suitable for use with embodiments of the present technology and are intended to represent a broad category of such computer components that are well known in the art. Thus, the computer system 600 of FIG. 6 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions can be composed of instructions that are stored on storage media (e.g., computer-readable media). The instructions can be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media can be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents. The present descriptions are intended to cover such alternatives, modifications, and equivalents as can be included within the spirit and scope of the disclosure as defined by the appended claims and otherwise appreciated by one of ordinary skill in the art. In several respects, embodiments of the present disclosure can act to close the loopholes in the current industry practices in which good business practices and logic are lacking because it is not feasible to implement with current resources and tools.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

What is claimed is:

1. A method for capturing video from a sensor triggered camera, comprising:
receiving from a camera a video stream into buffer storage, the video stream associated with a period of time;
receiving from a sensor a signal indicating a triggering event during the period of time;
capturing a portion of the video stream in the buffer storage beginning prior to the triggering event and ending after the triggering event, the captured portion of the video stream being a subset of the video stream; and
saving the captured portion of the video stream in memory.

2. The method of claim 1, further comprising associating a time stamp, a GPS location, and non-video data with the saved portion of the video stream.

3. The method of claim 2, wherein the time stamp comprises one or more of a time of the triggering event, a time associated with the beginning of the saved portion of the video stream, and a time associated with the end of the saved portion of the video stream.

4. The method of claim 2, further comprising transmitting the time stamp, the GPS location, the non-video data, and the saved portion of the video stream to a networked intelligent agent.

5. The method of claim 2, wherein the non-video data comprises one or more of an identifier of the sensor that was triggered, an identifier of a vehicle on which the sensor is located, an identifier of a driver of the vehicle, a service history of the vehicle, and a status of other sensors that sense conditions of the vehicle or subsystems of the vehicle.

6. The method of claim 1, wherein receiving from the sensor the signal indicating a triggering event comprises receiving from the sensor a signal indicating a collision by a moving vehicle.

7. The method of claim 6, further comprises receiving the signal from an accelerometer sensor.

8. A method for capturing video from a sensor triggered vehicle camera, the method comprising:
receiving from a camera on a vehicle a continuous video stream into buffer storage;
receiving from a sensor on the vehicle a signal to transfer the continuous video stream from the buffer storage to a memory;
receiving from a system controller on the vehicle a first predefined time, the first predefined time indicating a time prior to the receiving of the signal in which to initiate a transfer of the continuous video stream from the buffer storage to the memory;
receiving from the system controller on the vehicle a second predefined time, the second predefined time indicating a time after the receiving of the signal to transfer in which to stop the transfer of the continuous video stream from the buffer storage to the memory; and
saving the continuous video stream in the memory.

9. The method of claim 8, further comprising associating a time stamp, a GPS location, and an identifier of the vehicle with the saved portion of the video stream.

10. The method of claim 9, wherein the time stamp comprises one or more of a time of the triggering event, a time associated with the beginning of the saved portion of the video stream, and a time associated with the end of the saved portion of the video stream.

11. The method of claim 9, further comprising transmitting the time stamp, the GPS location, the identifier of the vehicle, and the saved portion of the video stream to a networked intelligent agent.

12. The method of claim 8, wherein receiving from the sensor on the vehicle the signal to transfer the continuous video stream comprises receiving from the sensor a signal indicating a collision of the vehicle.

13. The method of claim 12, further comprises receiving the signal from an accelerometer sensor.

14. A system for capturing video from a sensor triggered vehicle camera, comprising:
a camera on a vehicle producing a continuous video stream;
a buffer storage communicatively coupled to the camera on the vehicle storing the continuous video stream for a period of time;
a sensor on the vehicle, the sensor communicatively coupled to the camera, the buffer storage and a memory on the vehicle;
a system controller on the vehicle, the system controller communicatively coupled to the camera, the sensor, the buffer storage, and the memory; and
an intelligent agent communicatively coupled over a network to the system controller on the vehicle, the intelligent agent configured to receive over the network from the system controller on the vehicle a portion of the saved continuous video stream, an associated time stamp, an associated GPS location, and an associated identifier of the vehicle.

15. The system of claim 14, wherein the sensor is capable of sensing a triggering event during the period of time of the continuous video stream.

16. The system of claim 15, wherein the system controller is operative to capture a portion of the video stream in the buffer storage beginning prior to the triggering event and ending after the triggering event, and saving the portion of the video stream in the memory.

17. The system of claim 16, wherein the time stamp comprises one or more of a time of the triggering event, a time associated with the beginning of the saved portion of the video stream, and a time associated with the end of the saved portion of the video stream.

18. The system of claim 14, wherein the sensor is operative to sense a collision of the vehicle.

19. The system of claim 14, wherein the sensor is operative to sense when a speed of the vehicle exceeds a predetermined speed limit.

20. The system of claim 14, wherein the sensor comprises one or more of an ultrasonic or microwave motion detector, a vibration sensor, a sound sensor, a differential pressure sensor, a radar sensor, a sonar sensor, a lidar sensor, a light sensor, a braking sensor, an accelerometer sensor, an impact sensor, a GPS sensor, and a video sensor.
